(19) United States
(12) Patent Application Publication
(10) Pub. No.: US 2003/0081682 A1
(43) Pub. Date: May 1, 2003

(54) Unit for and method of motion estimation and image processing apparatus provided with such estimation unit

(76) Inventors: Gerard Anton Lunter, Eindhoven (NL); Anna Pelagotti, Eindhoven (NL)

Correspondence Address: U.S. Philips Corporation, 580 White Plains Road, Tarrytown, NY, 10591, US

(21) Appl. No.: 10/264,028

(22) Filed: Oct. 3, 2002

(30) Foreign Application Priority Data
Oct. 8, 2001 (EP) 01203787.5

(51) Int. Cl. H04N 7/12

(52) U.S. Cl. 375/240.16

(57) ABSTRACT

The motion estimation unit (100) comprises a block-matcher (102) for calculating a start motion vector (110) by minimizing a predetermined cost function as a matching criterion for the block (116) of pixels with a further block of pixels (122) of a further image (120). The motion estimation unit (100) further comprises an optical flow analyzer (104) for calculating an update motion vector (111) based on the start motion vector (110) and which is designed to minimize a sum of errors associated with a set of optical flow equations corresponding to respective pixels of the block (116) of pixels. Finally the selector 106 of the motion estimation unit (100) selects the motion vector (126) by comparing the start motion vector (110) with the update motion vector (111).

The invention relates to a motion estimation unit for generating a motion vector corresponding to a block of pixels of an image, comprising:

a block-matcher for calculating a start motion vector by minimizing a predetermined cost function as a matching criterion for matching the block of pixels with a further block of pixels of a further image;

an optical flow analyzer for calculating an update motion vector based on the start motion vector and based on an optical flow equation for a pixel of the block of pixels; and

a selector to select as the motion vector, the start motion vector or the update motion vector, by comparing a first value of the matching criterion of the start motion vector with a second value of the matching criterion of the update motion vector.

The invention further relates to a motion estimation method of generating a motion vector corresponding to a block of pixels of an image, comprising the steps of

block-matching to calculate a start motion vector by minimizing a predetermined cost function as a matching criterion for matching the block of pixels with a further block of pixels of a further image;

optical flow analysis to calculate an update motion vector based on the start motion vector and based on an optical flow equation for a pixel of the block of pixels; and

selecting as the motion vector, the start motion vector or the update motion vector, by comparing a first value of the matching criterion of the start motion vector with a second value of the matching criterion of the update motion vector.

The invention further relates to an image processing apparatus comprising:

receiving means for receiving a signal representing images to be displayed;

such a motion estimation unit; and

a motion compensated image processing unit.

For motion estimation, two main techniques are usually distinguished namely correspondence-based methods and optical flow-based methods. The former are suitable for large motion. Optical flow-based methods are suited for small motion, and are fast and accurate. The concept of optical flow-based methods is to use the Optical Flow Equation (OFE) to compute a motion vector. The OFE is simply the linearization of the equation describing the hypothesis that luminance is constant along the motion trajectory. The constant-luminance hypothesis can be written as:

L(\overline{x}+\overline{tv},t)=const., (1)

for fixed \overline{x} and \overline{v}. Differentiating with respect to t yields

$$u \frac{\partial L}{\partial x} + v \frac{\partial L}{\partial y} = - \frac{\partial L}{\partial t} \qquad ( 2 )$$

with motion vector \overline{v}=(u, v), or written differently

$$\overline{v} \cdot gradL = - \frac{\partial L}{\partial t} , \qquad ( 3 )$$

Block-matching methods belong to the correspondence-based methods.

An embodiment of the motion estimation unit of the kind described in the opening paragraph is known from W099/17256. In that document neighboring spatio-temporal candidates are used as input for a block-recursive matching process. In addition, a further update vector is tested against the best candidate of the block-recursive matching process. This update vector is computed by applying a local, pixel-recursive process to the current block, which uses the best candidate of the block-recursive matching process as a start vector. The pixel-recursive process is based on optical flow equations. The final output vector is obtained by comparing the update vector from pixel recursion with the start vector from the block-recursive process and by selecting the one with the best match. The motion estimation unit according to the prior art has two disadvantages related to the optical flow part. First, the pixel-recursive scheme leads to an essentially unpredictable memory access, which is undesirable for hardware implementations. Second, the technique chosen to solve the aperture problem makes the method vulnerable to noise. With aperture problem is meant that a single optical flow equation with two unknowns must be solved, i.e. in Equation 2 both u and v are unknown.

It is a first object of the invention to provide a motion estimation unit of the kind described in the opening paragraph which is designed to estimate a relatively high quality motion vector field.

It is a second object of the invention to provide a motion estimation method of the kind described in the opening paragraph to estimate a relatively high quality motion vector field.

It is a third object of the invention to provide an image processing apparatus of the kind described in the opening paragraph which is designed to perform motion compensated image processing based on a relatively high quality motion vector field.

The first object of the invention is achieved in that the optical flow analyzer is designed to minimize a sum of errors associated with a set of optical flow equations corresponding to respective pixels of the block of pixels. The major difference between the motion estimation units according to the prior art and according to the invention is that the optical flow analyzer of the motion estimation unit according to the invention is not recursive but block based. In the motion estimation unit according to the prior art a solution of the optical flow equation corresponding to each pixel of the block of pixels is estimated individually and used to estimate a solution of the optical flow equation corresponding to a next pixel. In the motion estimation unit according to the invention a set of optical flow equations corresponding to multiple pixels is solved, i.e. the sum of errors associated with the set of optical flow equations corresponding to multiple pixels of the block of pixels is minimized. Because of this the effects of noise are suppressed. The result is a motion vector field which is relatively accurate. This has benefits, e.g. coding applications because of less residual image data. Another application which profits from a high quality motion vector field is de-interlacing, as here the sub-pixel accuracy of the motion vector field is crucial. Another advantage is that good candidates stabilize the motion estimation unit, making it less likely that a wrong motion vector candidate, i.e. one which does not correspond to the true motion but which accidentally exhibits a low match error gets selected.

An embodiment of the motion estimation unit according to the invention is characterized in that a particular error equals zero if a particular optical flow equation corresponding to a particular pixel is satisfied. The following notation is introduced:

The pixels in the block of pixels are indexed by i.

$$X = \frac{\partial L}{\partial x} , Y = \frac{\partial L}{\partial y} a n d T = \frac{\partial L}{\partial t} ;$$

Lᵢ is the luminance value of the pixel in the block with index i;

Xᵢ is the x-derivative of L at that pixel;

Yᵢ is the y-derivative of L at that pixel;

Tᵢ is the t-derivative of L at that pixel;

For a particular pixel i the optical flow equation 2 can be rewritten as:

uXᵢ+vYᵢ+Tᵢ=0 (4)

Only for the exact values of u and v Equation 4 is satisfied: the left term equals the right term, i.e. zero. The idea is to use the left term as error term, since the worse the estimations of the values of u and v are, the more the left term deviates from zero. Notice that the square of zero equals zero.

The pixels of the block of pixels give rise to an over-determined set of optical flow equations in two unknowns. Instead of solving multiple equations at once, the errors made in the equations are minimized, resulting in a unique solution of the motion vector \overline{v}=(u, v). Because of computational simplicity it is preferred that the sum of squares of the errors is minimized. The total squared error is:

Σ(uXᵢ+vYᵢ+Tᵢ)², (5)

To minimize this in u and v, derivatives are taken and equated to zero. Solving for u and v then yields:

$$u = \frac{{\sum }_{i} {X}_{i} {Y}_{i} {\sum }_{i} {Y}_{i} {T}_{i} - {\sum }_{i} {Y}_{i}^{2} {\sum }_{i} {X}_{i} {T}_{i}}{{\sum }_{i} {X}_{i}^{2} {\sum }_{i} {Y}_{i}^{2} - {( {\sum }_{i} {X}_{i} {Y}_{i} )}^{2}} \\ v = \frac{{\sum }_{i} {X}_{i} {Y}_{i} {\sum }_{i} {X}_{i} {T}_{i} - {\sum }_{i} {X}_{i}^{2} {\sum }_{i} {Y}_{i} {T}_{i}}{{\sum }_{i} {X}_{i}^{2} {\sum }_{i} {Y}_{i}^{2} - {( {\sum }_{i} {X}_{i} {Y}_{i} )}^{2}} \qquad ( 6 )$$

A general approach for solving optical flow equations is adding a smoothness constraint to overcome the aperture problem. An example of this approach is disclosed by Horn and Schunk in the article “Determining optical flow” in Artificial Intelligence 1981, vol. 17, pages 185-203. The smoothness constraint term is non-linear, resulting in an iterative process to solve the equations.

In an embodiment of the motion estimation unit according to the invention, the optical flow analyzer is designed to calculate an update motion vector based on a portion of the pixels of the block of pixels. Instead of taking into account all pixels of the block of pixels to define optical flow equations, this embodiment sub-samples the block of pixels. E.g. a sub-sampling factor of 4 to 8 is applied. The advantage is that the number of calculations is reduced while the accuracy of the update motion vector is still relatively high.

In an embodiment of the motion estimation unit according to the invention the optical flow analyzer comprises a gradient calculator which is designed to calculate luminance gradients according to a Prewitt gradient operator. To calculate the x-derivative the following kernel is used:

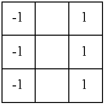

And to calculate the y-derivative the following kernel is used:

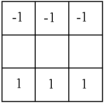

In an embodiment of the motion estimation unit according to the invention the optical flow analyzer comprises a gradient calculator which is designed to calculate luminance gradients according to a Sobel gradient operator. To calculate the x-derivative the following kernel is used:

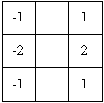

And to calculate the y-derivative the following kernel is used:

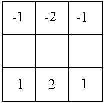

In an embodiment of the motion estimation unit according to the invention the optical flow analyzer comprises a gradient calculator which is designed to calculate luminance gradients according to a Robert gradient operator. To calculate the x-derivative the following kernel is used:

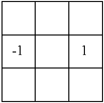

And to calculate the y-derivative the following kernel is used:

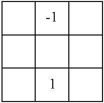

Here the numbers are the multipliers for the luminance values at the corresponding pixel positions, i.e. kernel coefficients. E.g. Robert's gradient operator corresponds to

gradL=(L(x+1, y)−L(x−1, y), L(x, y+1)−L(x, y−1)) (7)

For notational simplicity, overall scaling factors of ½, ⅛ and ⅙ for Robert's, Sobel's and Prewitt's gradient operator respectively have been left out.

In an embodiment of the motion estimation unit according to the invention the block-matcher is recursive. A relatively good motion estimation unit is known from the article “True-Motion Estimation with 3-D Recursive Search Block Matching” by G. de Haan et. al. in IEEE Transactions on circuits and systems for video technology, vol. 3, no. 5, October 1993, pages 368-379. That 3DRS block-matcher is in principle accurate up to ¼ pixels. This accuracy can be indeed achieved in large textured regions with translation motion, for example in a camera pan. However, to reach this accuracy in smaller regions, or in regions with more complicated motion, e.g. zooming, the 3DRS matcher has to select many update candidates, and this is undesirable as this in general leads to a degradation of spatial consistency. For this reason, update candidates are suppressed by means of penalties. This leads to a spatially and temporally stable vector field, but also to a sub-optimal accuracy. This embodiment according to the invention combines the good aspects of both a block-matching method and an optical flow-based method. The idea is that the block matcher is used to find the start vector field up to medium accuracy. The residual motion vector is small enough to allow an optical flow method to be applied by the optical flow analyzer. Compared with the 3DRS block-matcher according to the prior art, fewer update candidates have to be considered, as tracking of motion is done mainly by the optical flow analyzer. This improves the efficiency of the motion estimation unit.

In an embodiment of the motion estimation unit according to the invention, the optical flow analyzer comprises a reliability unit to check whether the update motion vector is reliable. Sometimes the set of optical flow equations is ill-determined, for example because there is only a single edge in the block of pixels so that all gradients point in one direction. If this happens, the denominator in Equation 6 becomes small compared to

$${\sum }_{i} {X}_{i}^{2} {\sum }_{i} {Y}_{i}^{2} .$$

As a measure of reliability of the update motion vector the following number is calculated:

$$100 * \frac{{\sum }_{i} {X}_{i}^{2} {\sum }_{i} {Y}_{i}^{2} - {( {\sum }_{i} {X}_{i} {Y}_{i} )}^{2}}{{\sum }_{i} {X}_{i}^{2} {\sum }_{i} {Y}_{i}^{2}} \qquad ( 8 )$$

and a threshold of 90 or 95 for accepting the update motion vector as a candidate vector for the block-matcher.

Modifications of the image processing apparatus and variations thereof may correspond to modifications and variations thereof of the motion estimation unit described. The image processing apparatus may comprise additional components, e.g. receiving means for receiving a signal representing images and a display device for displaying the processed images. The motion compensated image processing unit might support one or more of the following types of image processing:

De-interlacing: Interlacing is the common video broadcast procedure for transmitting the odd or even numbered image lines alternately. De-interlacing attempts to restore the full vertical resolution, i.e. make odd and even lines available simultaneously for each image;

Up-conversion: From a series of original input images a larger series of output images is calculated. Output images are temporally located between two original input images; and

Temporal noise reduction. This can also involve spatial processing, resulting in spatial-temporal noise reduction.

These and other aspects of the motion estimation unit, of the method and of the image processing apparatus according to the invention will become apparent from and will be elucidated with respect to the implementations and embodiments described hereinafter and with reference to the accompanying drawings, wherein:

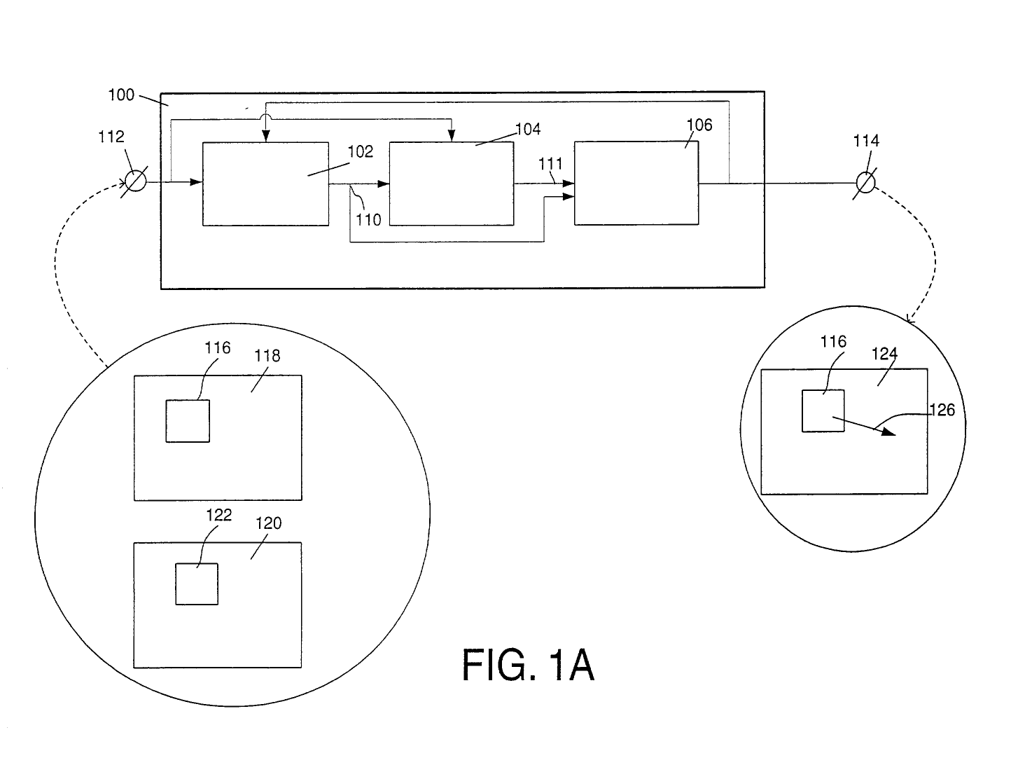

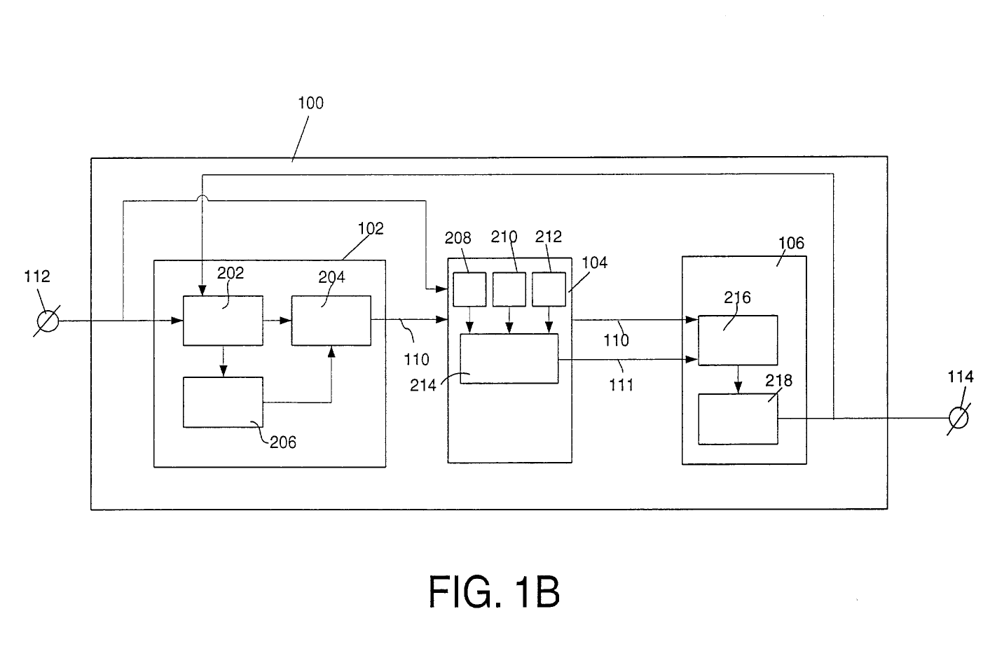

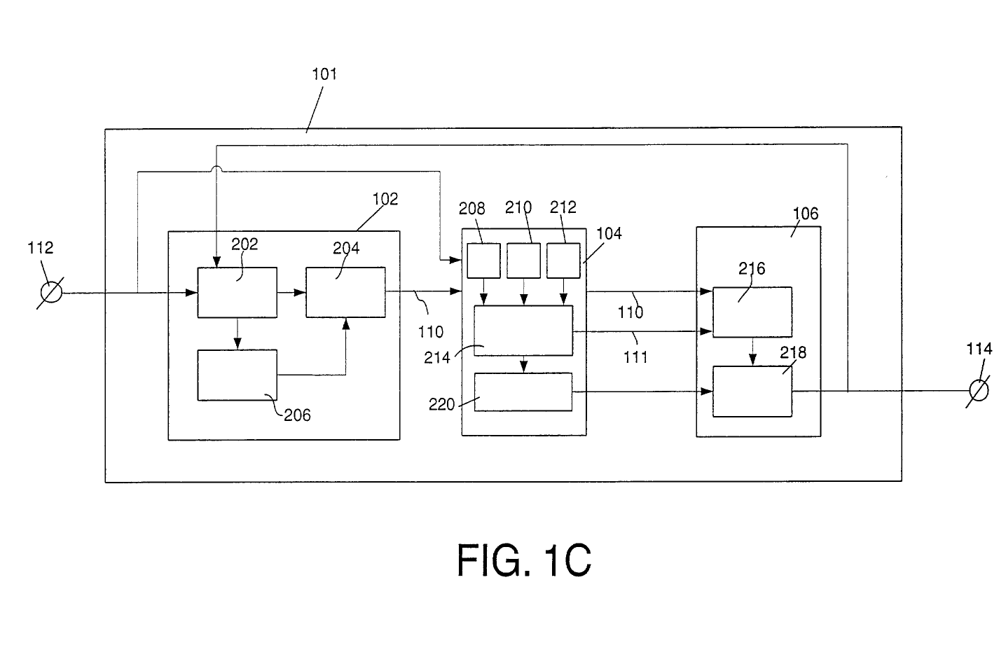

FIG. 1A schematically shows an embodiment of the motion estimation unit;

FIG. 1B schematically shows an embodiment of the motion estimation unit in more detail;

FIG. 1C schematically shows an embodiment of the motion estimation unit comprising a reliability unit; and

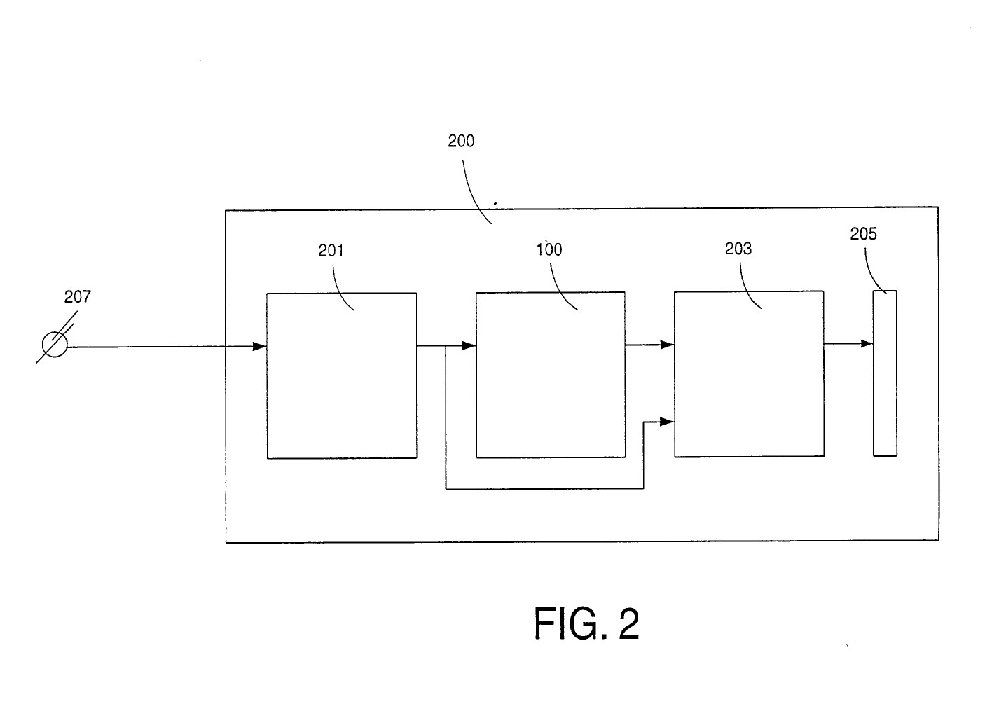

FIG. 2 schematically shows an embodiment of the image processing apparatus; Corresponding reference numerals have the same meaning in all of the Figs.

FIG. 1A schematically shows an embodiment of the motion estimation unit 100 according to the invention. The motion estimation unit 100 is designed to generate a motion vector 126 corresponding to a block 116 of pixels of an image 118. All motion vectors of one image are called a motion vector field 124. The motion estimation unit 100 comprises:

a block-matcher 102 for calculating a start motion vector 110 by minimizing a predetermined cost function as a matching criterion for matching the block 116 of pixels with a further block of pixels 122 of a further image 120;

an optical flow analyzer 104 for calculating an update motion vector 111 based on the start motion vector 110 and which is designed to minimize a sum of errors associated with a set of optical flow equations corresponding to respective pixels of the block 116 of pixels; and

a selector 106 to select as the motion vector 126, the start motion vector 110 or the update motion vector 111, by comparing a first value of the matching criterion of the start motion vector 110 with a second value of the matching criterion of the update motion vector 111.

The input of the motion estimator unit 100 comprises images and is provided at an input connector 112. The output of the motion estimator unit 100 are motion vector fields, e.g. 124 and is provided at an output connector 114.

FIG. 1B schematically shows the embodiment of the motion estimation unit 100 described in connection with FIG. 1A in more detail. The behavior of the block-matcher 102 is as follows. First the generating means 202 generates for the block 116 of pixels, a set of candidate motion vectors. Then the block-match error calculator 206 calculates for these candidate motion vectors the match errors. Then the selector 204 selects the start motion vector 110 from the set of candidate motion vectors on the basis of these match errors. This start motion vector 110 is selected because its match error has the lowest value. A match error being calculated by the block-match error calculator 206 corresponds to the SAD: sum of absolute luminance differences between pixels in the block 116 of pixels of image 118, and the pixels of a further block 122 in the next image 120 corresponding to the block 116 of pixels shifted by a candidate motion vector.

The behavior of the optical flow analyzer 104 is as follows. The gradient operators 208, 210 and 212 calculate the luminance gradients in x-, y- and time-direction, respectively. Typically the gradients of all pixels of a block of pixels are calculated. In the case that optical flow equations are used of only a portion of the block of pixels, less gradients have to be calculated. Based on the pixels which are taken into account, a set of optical flow equations according to Equation 2 is defined. Optimizer 214 is designed to minimize the sum of errors associated with the set of optical flow equations. A preferred embodiment of the motion estimation unit according to the invention comprises running counters that accumulate the values of

$${\sum }_{i} {X}_{i}^{2} , {\sum }_{i} {X}_{i} {Y}_{i} , {\sum }_{i} {Y}_{i}^{2} , {\sum }_{i} {X}_{i} {T}_{i} , {\sum }_{i} {Y}_{i} {T}_{i}$$

to compute the update motion vector \overline{v}=(u, v) 111 according to Equation 6.

Finally the two motion vectors, i.e. the start motion vector 110 being calculated by the block-matcher 102 and the update motion vector 111 being calculated by the optical flow analyzer 104 are analyzed by the selector 106 to select the motion vector 126. To achieve this, the block-match error calculator 216 calculates for both motion vectors the match errors, e.g. on the basis of the sum of absolute differences. Then the selector 218 selects the motion vector 126 on the basis of these match errors. The selected motion vector 126 is a possible motion vector candidate for other blocks. Hence the selected motion vector 126 is provided to the generating means 202 of the block-matcher 102.

FIG. 1C schematically shows an embodiment of the motion estimation unit 101 comprising a reliability unit 220 to check whether the update motion vector 111 is reliable. Sometimes the set of optical flow equations is ill-determined, for example because there is only a single edge in the block of pixels so that all gradients point in one direction. If this happens, the denominator in Equation 5 becomes small compared to

$${\sum }_{i} {X}_{i}^{2} {\sum }_{i} {Y}_{i}^{2} .$$

As a measure of reliability of the update motion vector a reliability measure is calculated as specified in Equation 8. If the value of the reliably measure of a particular update motion vector is below a predefined threshold, e.g. 90 or 95 then it is assumed that the particular update motion vector is not reliable and the selector 106 is informed about that.

FIG. 2 schematically shows elements of an image processing apparatus 200 comprising:

receiving means 201 for receiving a signal representing images to be displayed after some processing has been performed. The signal may be a broadcast signal received via an antenna or cable but may also be a signal from a storage device like a VCR (Video Cassette Recorder) or Digital Versatile Disk (DVD). The signal is provided at the input connector 207.

a motion estimator unit 100 as described in connection with FIG. 1A and FIG. 1B;

a motion compensated image processing unit 203; and

a display device 205 or displaying the processed images. This display device is optionally.

The motion compensated image processing unit 203 requires images and motion vectors as its input.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. Notice that the functions of the block-match error calculators 216 and 206 are similar. Optionally one of these can perform both tasks. The same holds for the selectors 204 and 218.

1. A motion estimation unit (100) for generating a motion vector (126) corresponding to a block (116) of pixels of an image (118), comprising:
a block-matcher (102) for calculating a start motion vector (110) by minimizing a predetermined cost function as a matching criterion for matching the block (116) of pixels with a further block of pixels (122) of a further image (120);
an optical flow analyzer (104) for calculating an update motion vector (111) based on the start motion vector (110) and based on an optical flow equation for a pixel of the block (116) of pixels; and
a selector (106) to select as the motion vector (126), the start motion vector (110) or the update motion vector (111), by comparing a first value of the matching criterion of the start motion vector (110) with a second value of the matching criterion of the update motion vector (111), characterized in that the optical flow analyzer (104) is designed to minimize a sum of errors associated with a set of optical flow equations corresponding to respective pixels of the block (116) of pixels.

2. A motion estimation unit (100) as claimed in claim 1, characterized in that a particular error equals zero if a particular optical flow equation corresponding to a particular pixel is satisfied.

3. A motion estimation unit (100) as claimed in claim 1, characterized in that the optical flow analyzer (104) is designed to calculate an update motion vector (111) based on a portion of the pixels of the block (116) of pixels.

4. A motion estimation unit (100) as claimed in claim 1, characterized in that the optical flow analyzer (104) comprises a gradient calculator (208-212) which is designed to calculate luminance gradients according to a Prewitt gradient operator.

5. A motion estimation unit (100) as claimed in claim 1, characterized in that the optical flow analyzer (104) comprises a gradient calculator (208-212) which is designed to calculate luminance gradients according to a Sobel gradient operator.

6. A motion estimation unit (100) as claimed in claim 1, characterized in that the optical flow analyzer (104) comprises a gradient calculator (208-212) which is designed to calculate luminance gradients according to a Robert gradient operator.

7. A motion estimation unit (100) as claimed in claim 1, characterized in that the block-matcher (102) is recursive.

8. A motion estimation unit (101) as claimed in claim 1, characterized in that the optical flow analyzer (104) comprises a reliability unit (214) to check whether the update vector (111) is reliable.

9. A motion estimation method of generating a motion vector (126) corresponding to a block (116) of pixels of an image (118), comprising the steps of
block-matching to calculate a start motion vector (110) by minimizing a predetermined cost function as a matching criterion for matching the block (116) of pixels with a further block of pixels (122) of a further image (120);
optical flow analysis to calculate an update motion vector (111) based on the start motion vector (110) and based on an optical flow equation for a pixel of the block (116) of pixels; and
selecting as the motion vector (126), the start motion vector (110) or the update motion vector (111), by comparing a first value of the matching criterion of the start motion vector (110) with a second value of the matching criterion of the update motion vector (111), characterized in that in the optical flow analysis a sum of errors associated with a set of optical flow equations corresponding to respective pixels of the block of pixels is minimized.

10. An image processing apparatus (200) comprising:
receiving means (201) for receiving a signal representing an image (118) to be displayed;
a motion estimation unit (100) for generating a motion vector (126) corresponding to a block (116) of pixels of the image (118), comprising:
a block-matcher (102) for calculating a start motion vector (110) by minimizing a predetermined cost function as a matching criterion for matching the block (116) of pixels with a further block of pixels (122) of a further image (120);
an optical flow analyzer (104) for calculating an update motion vector (111) based on the start motion vector (110) and based on an optical flow equation for a pixel of the block (116) of pixels; and
a selector (106) to select as the motion vector (126), the start motion vector (110) or the update motion vector (111), by comparing a first value of the matching criterion of the start motion vector (110) with a second value of the matching criterion of the update motion vector (111); and
a motion compensated image processing unit (203) characterized in that the optical flow analyzer (104) is designed to minimize a sum of errors associated with a set of optical flow equations corresponding to respective pixels of the block (116) of pixels.

11. An image processing apparatus (200) as claimed in claim 10, characterized in that the motion compensated image processing unit (203) is designed to reduce noise in the image (118).

12. An image processing apparatus (200) as claimed in claim 10, characterized in that the motion compensated image processing unit (203) is designed to de-interlace the image (118).

13. An image processing apparatus (200) as claimed in claim 10, characterized in that the motion compensated image processing unit (203) is designed to perform an up-conversion.
